(19) United States
(12) Patent Application Publication
(10) Pub. No.: US 2006/0148367 A1
(43) Pub. Date: Jul. 6, 2006

(54) Discharge lamp producing method

(76) Inventors: Yuichrio Ogino, Takatsuki-shi (JP); Yoshimitsu Mino, Sourakugun (JP); Akio Kikuchi, Hirakata-shi (JP); Hironobu Ueno, Takaishi-shi (JP)

Correspondence Address: SNELL & WILMER L.L.P., 600 ANTON BOULEVARD, SUITE 1400, COSTA MESA, CA, 92626, US

(21) Appl. No.: 10/546,577

(22) PCT Filed: Mar. 26, 2004
(86) PCT No.: PCT/JP04/04330

§ 371 Date: Aug. 22, 2005

(30) Foreign Application Priority Data
Mar. 26, 2003 (JP) 2003-086488

(51) Int. Cl. H01J 9/00; H05B 33/10

(52) U.S. Cl. 445/26

(57) ABSTRACT

In the case of forming a pair of electrodes by irradiating a predetermined site on an electrode assembly disposed in a sealed discharge space and melt-cutting the same, the predetermined site on the electrode assembly is irradiated with the laser beam emitted from a direction that forms a predetermined angle θ1 with a plane that is orthogonal to a longitudinal direction of the electrode assembly. Therefore, the discharge lamp manufacturing method according to the present invention can appropriately control which electrode's side the melted electrode material moves to.

### TECHNICAL FIELD

The present invention relates to a manufacturing method for a discharge lamp, and particularly to a manufacturing method for a short-arc type discharge lamp in which the distance between electrodes is made short to gain a light source that is close to a point light source.

### BACKGROUND ART

In recent years, there has been active development for projection type image display apparatuses that realize image display on large screens, such as liquid crystal projectors and projectors using DMDs (Digital Micromirror Devices). As a light source used for such projectors, discharge lamps in which the distance between electrodes is made short to gain a light that is close to a point source, such as short-arc type high pressure mercury lamps, are attracting attention.

As a manufacturing method for such a discharge lamp, Japanese laid-open patent publication No. 3330592, for instance, discloses a manufacturing method. By this method, firstly an electrode assembly including an electrode structure, which is to be formed into a pair of electrodes for a discharge lamp, is inserted into a discharge-lamp glass bulb including an arc tube part and side tube parts, and the side tube parts are sealed so as to form the arc tube part in which the electrode structure is disposed, and then the pair of the electrodes is formed within the arc tube part by selectively melt-cutting a part of the electrode structure.

In the above-described discharge lamp manufacturing method, a predetermined position on a tungsten rod, which is included in the electrode assembly, is melted by heat using laser irradiation. After the irradiation is stopped, the electrode material is gradually cooled from parts near to the areas where will be formed into bases of the respective electrodes. As a result, the tungsten rod is cut by the effect of the surface tension (Such a cutting process is called “Youyu Setsudan” (“melt cutting”) or simply called “Yodan” (an abbreviation for “Youyu Setsudan”).

For realizing mass production by such a manufacturing process using the melt cutting, it is preferable that the pair of the electrodes is formed by performing the laser irradiation twice or less. In other words, by the first laser irradiation, the predetermined position on the electrode assembly is melt-cut and the tip of one of the electrodes is processed so as to be in a semi-sphere shape, and by the second laser irradiation, the tip of the other one of the electrodes is processed so as to be in the semi-sphere shape. However, the inventors found that it is difficult to control which electrode's tip is to be processed. If it is uncertain which tip is to be processed, it is also uncertain which electrode is to be subjected to the second laser radiation. Therefore, this is a real problem for the manufacturing of the discharge lamp.

In view of above-described problem, the present invention therefore aims to provide a discharge lamp manufacturing method for forming a pair of electrodes by performing laser irradiation from the outside of the arc tube, thereby melt-cutting the electrode assembly at a predetermined position, wherein the discharge lamp manufacturing method can appropriately control which electrode's tip is to be processed by the first laser irradiation.

### DISCLOSURE OF THE INVENTION

The above-described object can be achieved by a discharge lamp manufacturing method for inserting an electrode assembly, which includes a rod that is to be formed into a pair of electrodes, into a discharge-lamp glass bulb having an arc tube part and two side tube parts respectively formed at ends of the arc tube part, sealing each side tube part, and melt-cutting a part of the electrode assembly by irradiating the part with a laser beam emitted from outside of the discharge-lamp glass bulb, the manufacturing method comprising: a laser irradiation step of irradiating a predetermined site on the electrode assembly with the laser beam emitted from a direction that forms a predetermined angle θ1 with a plane that is orthogonal to a longitudinal direction of the electrode assembly, thereby cutting the part of the electrode assembly, and shaping a tip of one of the electrodes that are formed as a result of the cutting, the predetermined angle θ1 being more than 0°

The inventors of the present invention firstly tried to melt-cut the part of the electrode assembly by horizontally irradiating the part with the laser beam. As a result of melt-cutting the part by horizontally irradiating an electrode structure 42 of the electrode assembly with a laser (FIG. 1A), the inventors found that it is impossible to control which electrode's side the melted electrode material moves toward (see FIG. 1B and FIG. 1C). In this case, it is uncertain which electrode's tip is to be processed so as to have a semi-sphere shape. Therefore, for processing the other electrode's tip so as to have a semi-sphere shape, it is also uncertain which electrode's tip is to be subjected to the second laser irradiation. This is a big problem for mass production. The above-described discharge lamp manufacturing method is a result of keen examinations for solving the problem.

The discharge lamp manufacturing method according to the present invention can appropriately control which electrode's tip is to be processed so as to have a semi-sphere shape, and therefore it is clear which electrode should be subjected to the second laser irradiation.

It is preferable that the predetermined angle θ1 is equal to or less than 45°. Note that although the lower limit of the predetermined angle θ1 is acceptable if it is more than 0°, it is preferable that θ1 is not less than 5°. If this angle is too large, the shape of a site on the electrode assembly, where is irradiated with the laser beam, becomes an ellipse, and the site might not be heated enough for the melt-cutting, or the lens effect of the glass material included in the arc tube part might have influence on energy efficiency of the laser beam. Therefore, it is preferable that the angle θ1 is equal to or less than 45°. However, the upper limit of the angle θ1 depends on the type of the lamp and the shape and the material of the arc tube part. According to the examination performed by the inventors of the present invention, it is preferable that the angle θ1 is between approximately 5° and approximately 15°.

It is preferable that a center point of the predetermined site is nearer to the one of the electrodes than a center point C of the electrode assembly within a discharge space is, the discharge space being formed after each side tube part is sealed.

By setting a center point of the predetermined site nearer to the one of the electrodes than a center point C of the electrode assembly within a discharge space is, it becomes possible to more surely shaping the tip of the one of the electrodes. When the center point of the predetermined site is substantially identical with the center point C, it is sometimes impossible to properly process the desired position, may be because the laser beam has a width. Of course, an incidence rate of such problem depends on several conditions, such as the structure of the electrode assembly, that is presence or absence of covering materials, which are described later, and the shapes and the positions of the covering materials.

The discharge lamp manufacturing method may further comprise another laser irradiation step of irradiating the other one of the electrodes with a laser beam, thereby shaping a tip of the other one of the electrodes. However, the present invention is not limited to this, and it is possible to form the electrodes by performing the laser irradiation only once. Especially, direct-current discharge lamps can be manufactured by performing the laser irradiation only once, from a practical view point. However, presumably, there are many cases where it is preferable to perform the second laser irradiation. Note although the second laser irradiation may be performed by irradiating the tip of the electrode with a laser beam at an angle, it is confirmed that the laser irradiation may be performed by horizontally irradiating the tip as well. The number of laser irradiation is not limited to twice, and it may be performed three times or more to arrange the shape of the tip of the electrode.

More specifically, the present invention may be the discharge lamp manufacturing method, wherein the electrode assembly is a tungsten rod to which two covering members are attached, the covering members to be respectively fixed to the tips of the electrodes, in the laser irradiation step, the tungsten rod is cut, and a portion of the tungsten rod, which is to be formed into the one of the electrodes, and a part of one of the covering members are melted and integrated together, and the tip of the one of the electrodes is shaped so as to have a semi-sphere shape, and in the another laser irradiation step, a portion of the tungsten rod, where is to be formed into the other one of the electrodes, and a part of the other one of the covering members are melted and integrated together, and the tip of the other one of the electrodes is shaped so as to have a semi-sphere shape. The covering members may be in coil shapes. However, the present invention is not limited to this. The covering members may be in cylindrical shape.

0 mm<D≦4.5 mm may be satisfied, where D (mm) is a distance between the electrodes in final form, and it is preferable that D is equal to or less than 2 mm. To realize this structure, of course it is preferable to optimize several conditions, such as the positions where the covering members are attached to, the diameters of the covering members and the tungsten rod, and the output level of the laser.

### BRIEF DESCRIPTION OF THE DRAWINGS

FIG. 1 is a drawing for explaining a result of a melt-cutting performed by horizontally irradiating an electrode structure 42 with a laser beam 60;

FIG. 2 is a drawing for explaining a discharge lamp manufacturing method applied in the embodiment of the present invention;

FIG. 3 shows an arc tube part 10 at a time after sealing parts 20 and 20′ are formed;

FIG. 4 shows a discharge lamp 100 in which a pair of electrodes 12 and 12′ are formed within a arc tube part 10;

FIG. 5A shows how a melt-cut part 18 is irradiated with a laser beam 60 from outside of an arc tube part 10 so as to melt-cut a tungsten rod 16 at a melt-cut part 18;

FIG. 5B shows a cross section of an arc tube part 10 along a plane S1 shown in FIG. 5A.

FIG. 6 is a drawing for explaining how a first laser irradiation is performed;

FIG. 7 is a drawing for explaining how a second laser irradiation is performed;

FIG. 8 shows an arc tube part 10 in which the electrode 12 is formed; and

FIG. 9 shows an example of a structure of an electrode assembly according to the embodiment of the present invention;

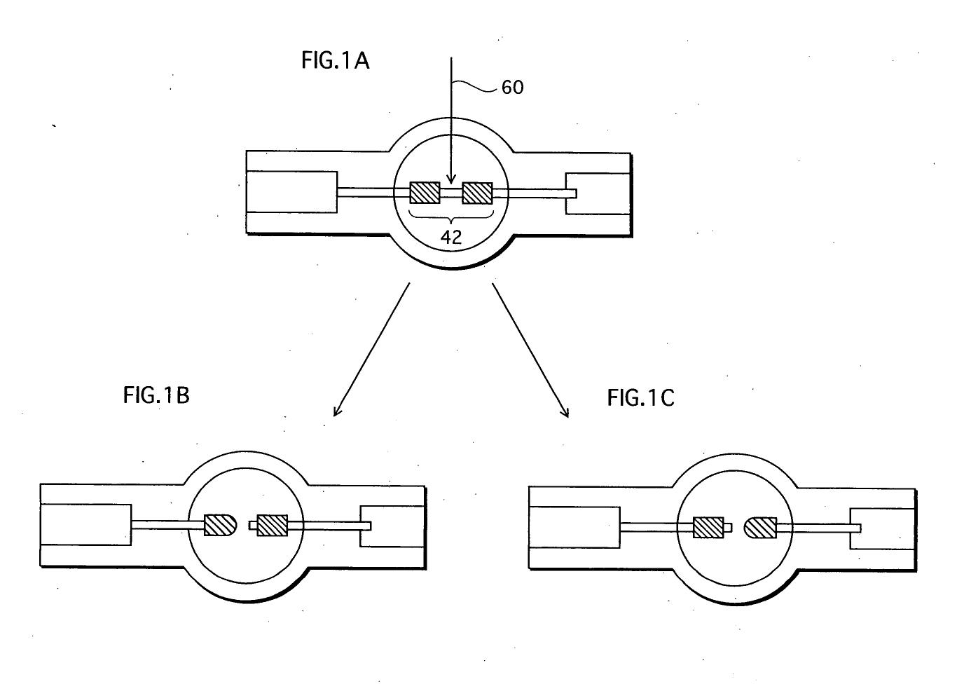

### BEST MODE FOR CARRYING OUT THE INVENTION

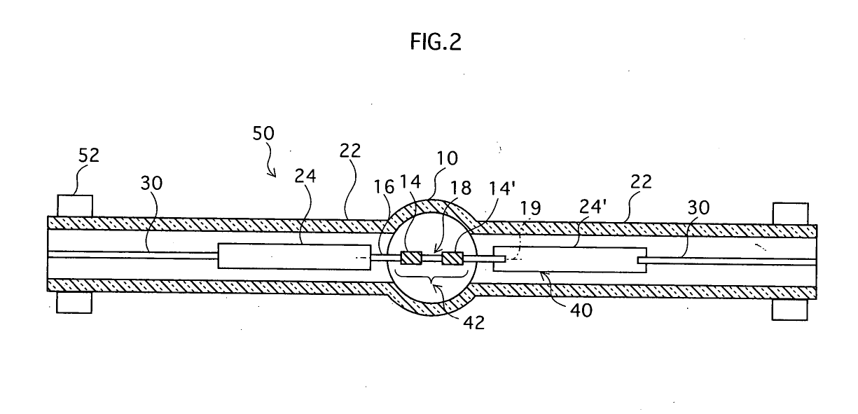

The following describes an embodiment of a discharge lamp manufacturing method according to the present invention, with reference to drawings. FIG. 2 to FIG. 4 are used for explaining a high-pressure mercury lamp manufacturing method as an example of the discharge lamp manufacturing method according to the present invention.

In this embodiment, a discharge-lamp glass bulb 50 (hereinafter simply called the “glass bulb”) and an electrode assembly 40 including an electrode structure 42, which is to be formed as a pair of electrodes, are firstly prepared, and then the electrode assembly is inserted into the glass bulb 50.

The glass bulb 50 includes an arc tube part 10, which is in a substantially spherical shape and to be formed as an arc tube of the discharge lamp, and side tube parts 22, which are extended from the arc tube part 10. A part of each side tube part becomes a sealing part of the discharge lamp. The glass bulb 50 may be held by chucks 52. In this embodiment, the glass bulb 50 is held horizontally. However, the glass bulb 50 may be held vertically.

The glass bulb 50 is made of silica glass, for instance. The arc tube part 10 in the glass bulb 50 used in the embodiment has an inside diameter of 6 mm and a thickness of 3 mm, and each of the side tube parts 22 has an inside diameter of 3.4 mm and a length of 250 mm in the longitudinal direction. The electrode assembly 40 includes a tungsten rod 16 that constitutes the electrode structure 42, and metal foils 24 and 24 that are respectively connected to both ends of the tungsten rod 16. Each of the metal foils 24 and 24′ are made of a molybdenum foil, for instance. The tungsten rod 16 is to be processed so as to form the electrode rod of each of the pair of the electrodes included in the discharge lamp. The length of the tungsten rod 16 is 20 mm for instance, and the outside diameter of the tungsten rod 16 is 0.4 mm for instance. A melt-cut part 18 is in the middle of the tungsten rod 16, which is to be melt-cut in a later step. Both outside ends of the melt-cut part 18 are to be processed so as to form the tips of the electrodes. In this embodiment, coils 14 and 14′ as covering members are attached to those outside ends. In this embodiment, the distance between the tips of the coils is approximately 1 mm to 1.5 mm. In this case, the distance D between the electrodes in final form becomes approximately 1 mm.

For attaching the coils 14 and 14′ to the tungsten rod 16, it is preferable that each of the coils 14 and 14′ is formed so that the inside diameter of each coil at the time it is wound up becomes shorter than the diameter of the tungsten rod 16, and the tungsten rod 16 is press-fitted into the coils. As a result, the coils 14 and 14′ wind around the tungsten rod 16 evenly, and when the melt-cut part is melt-cut by the laser irradiation, for instance, in a later step, the amount of the heat radiated from each coil becomes homogeneous. This means that the states of the electrodes and soon after they are processed with a laser beam having the same output level become less likely to have undesired variations. Of course, this is not limited to the press-fitting. The tungsten rod 16 may be attached to the coils by resistance welding after it is inserted into the coils 14 and 14′ that have larger inside diameters.

Each of the coils 14 and 14′ has a function to prevent the tips of the electrodes from being over heated when the produced discharge lamp is lit up. Therefore, the shapes of the covering members are not limited to the coil shapes. The covering members may have cylindrical shapes. Note that the outside diameter of each of the parts where the coils 14 and 14′ are attached is approximately 1.4 mm for instance. In this embodiment, the electrode structure, which is to be formed into the pair of electrodes, is constituted of the one tungsten rod 16. Therefore, the central axes of the pair of the electrodes are naturally the same. The tungsten rod 16 and the metal foil 24, and the tungsten rod 16 and the metal foil 24′ are connected to each other by welding. The metal foils 24 and 24′ are rectangular flat plates, and the sizes thereof may be adjusted according to requirements. Note that the other ends of the metal foils, which are not connected to the tungsten rod 16, are connected, by welding, with external leads 30 made of molybdenum.

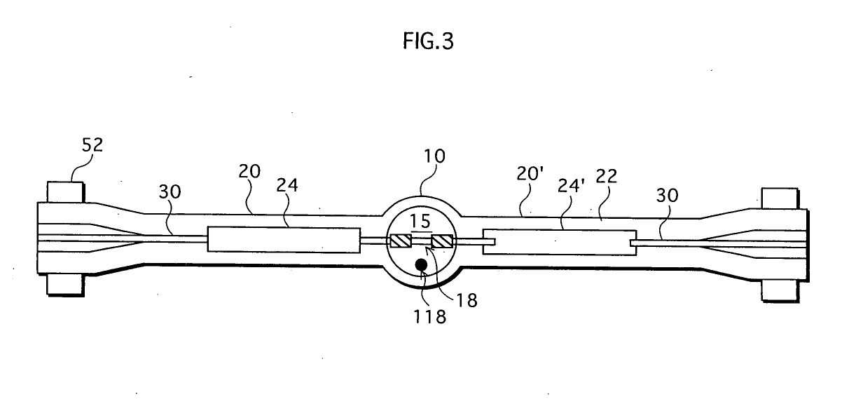

The electrode assembly 40 is inserted into the glass bulb 50 so that the electrode structure 42 is positioned within the arc tube part 10 of the glass bulb 50. Then, the sealing parts 20 and 20′ of the discharge lamp (See FIG. 3) are formed by closely attaching the side tube parts 22 of the glass bulb 50 to parts (the metal foils 24 and 24′) of the electrode assembly 40. The side tube parts 22 are closely attached (sealed) to the metal foils 24 and 24′ by a method in public domain. For instance, after the state of the glass bulb 50 is made ready for reducing the pressure within the glass bulb, the pressure within the glass bulb 50 is reduced (e.g. 20 kPa). The sealing part 20 is formable by closely attaching one of the side tube parts 22 and the metal foil 24, by heating and softening the side tubes 22 of the glass bulb 50 with use of a burner under the reduced pressure while rotating the glass bulb 50 with use of the chucks 52.

It becomes comparatively easy to enclose light-emitting material of the discharge lamp by enclosing the light-emitting material into the arc tube part 10 of the glass bulb 50 after forming the sealing part 20 and before forming the other sealing part 20′. Of course, it is possible to enclose the light-emitting material by making a hole after forming the sealing parts 20 and 20′, and plug up the hole after enclosing the light-emitting material.

In the embodiment, the arc tube part 10 encloses therein a mercury 118 as the light-emitting material (e.g. 150-200 mg/cm³), a rare gas at 5-20 kPa (e.g. argon), and a small amount of halogen (e.g. bromine). The halogen is not limited to an elementary substance (e.g. Br₂), and may be enclosed in the form of a halogen precursor. In this embodiment, the bromine is enclosed in the form of CH₂Br₂. The enclosed halogen (or the halogen induced from the halogen precursor) has a function for performing the process of a halogen cycle while the discharge lamp is operating.

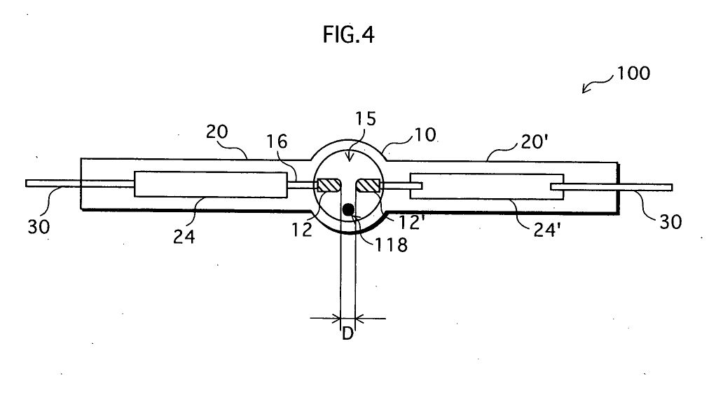

The arc tube part 10 as shown in FIG. 3, in which the electrode structure 42 is disposed in the sealed discharge space 15, is obtainable by forming the sealing parts 20 and 20′. Next, a pair of electrodes 12 and 12′ having predetermined distance D therebetween (see FIG. 4) is obtainable by selectively cutting the melt-cut part 18 disposed within the arc tube part 10. In this embodiment, the tips of the electrodes 12 and 12′ are processed so as to be in the semi-sphere shape by the laser irradiation from outside as described later. Then, by cutting the glass bulb 50 so that each of the sealing parts 20 and 20′ has a predetermined length, the discharge lamp 100, in which the pair of the electrodes 12 and 12′ are formed within the arc tube part 10, is obtainable.

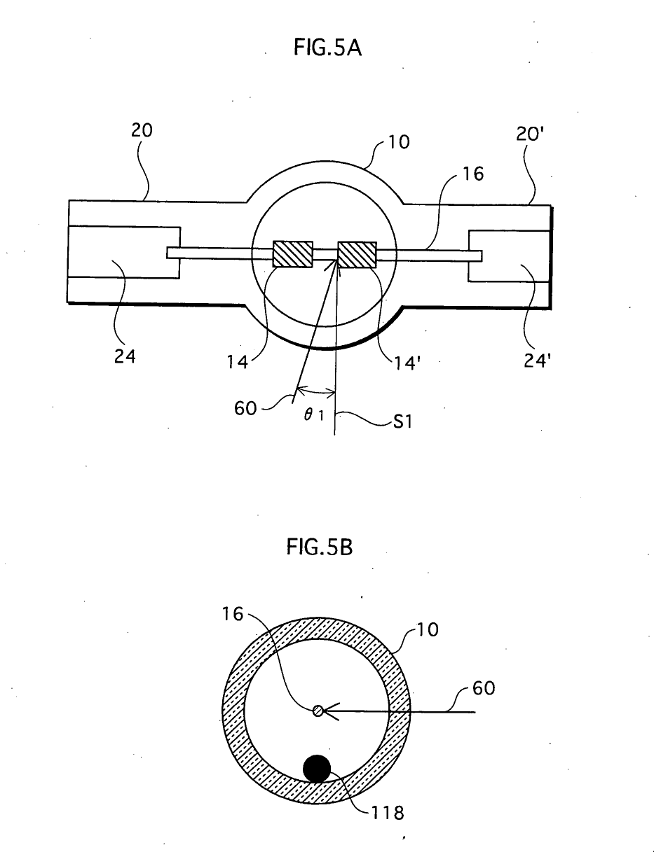

The manufacturing method for the discharge lamp in this embodiment has a characteristic that the first laser irradiation for melt-cutting the melt-cut part 15 is performed in such a manner that a laser beam 60 is emitted from a direction that forms a predetermined angle θ1 with a plane S1 (see FIG. 5A) that is substantially orthogonal to the longitudinal direction of the tungsten rod 16. FIG. 5 shows such a laser irradiation.

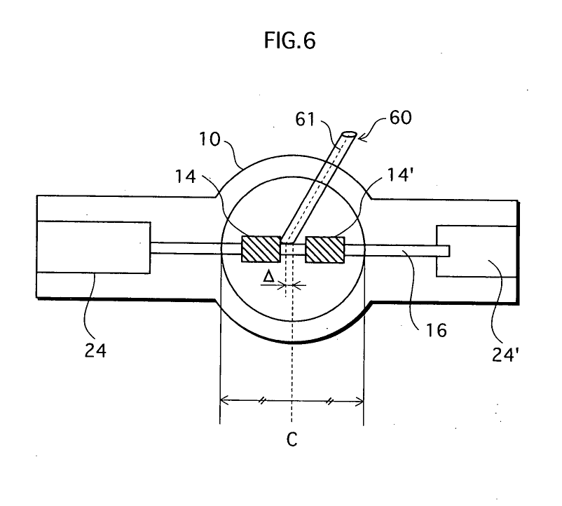

In this embodiment, when performing the first laser irradiation for melt-cutting the melt-cut part 18, the laser beam 60 is emitted from the direction that forms the predetermined angle θ1 with the plane S1 that is orthogonal to the longitudinal direction of the electrode assembly, as shown in FIG. 5A. FIG. 5B shows the cross section of the arc tube part 10 along the plane S1 shown in FIG. 5A. Although FIG. 5B shows that the laser beam 60 is horizontally emitted to the arc tube part 10, the direction of the emission is not limited to this. The advantageous effect of the present invention can be gained as long as the laser beam is emitted from the direction that forms the predetermined angle with the plane S1. By emitting the laser beam 60 from a first angle θ1, the melt-cut part 18 is melt-cut, the tungsten rod 16 and the coil 14′ are partly melted and integrated with each other, and the tip of the electrode 12′ is processed so as to be in the semi-sphere shape as shown in FIG. 5. As in this case, it is possible to control which of the electrode 12 and the electrode 12′ (see FIG. 6) is formed from the heated and melted part of the tungsten rod 16. In this way, the problem in manufacturing, which is described above in detail, can be solved.

Note that the predetermined angle θ1 is preferably more than 0° and not more than 45°. If this angle is too large, the shape of a site on the tungsten rod 16, where is irradiated with the laser beam, becomes an ellipse, and the site might not be heated enough for the melt-cutting. Further, the lens effect of the silica glass might have influence, depending on the shape of the arc tube part 10. The inventors of the present invention confirmed that it is more preferable that the angle is not less than 5° and not more than 15°.

Regarding the site where is irradiated with the laser beam 60, it is preferable that a center point of the site is nearer to the electrode whose tip is to be processed than a center point C of the electrode assembly within the discharge space is, as shown in FIG. 6. (Although the center point C and the central axis 61 are displaced from each other so as to have a distance A therebetween, the distance is not limited to the distance A.) This causes a difference between the pair of electrodes in cooling level of the electrode assembly, after the laser irradiation is stopped. The inventers speculate that while the electrodes are gradually cooled from the parts near to the bases of the respective electrodes by radiating heat via the tungsten rod 16, the electrode including the coil 14 is more readily cooled than the other electrode because the center point C and the central axis 61 are displaced from each other, and the melt cutting by the surface tension is readily caused.

By the above-described laser irradiation, the tip of the tungsten rod 16 and the coil 14′ are melted and integrated with each other and the tip is processed so as to be in the semi-sphere shape, in order to form the electrode 12′.

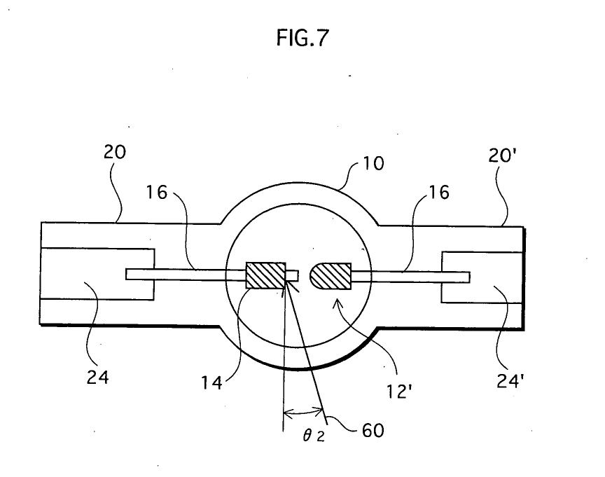

In this embodiment, the tip of the other electrode is processed by performing the second irradiation. FIG. 7 shows the process in which the second irradiation is performed.

As shown in FIG. 7, the laser beam 60 is emitted to the tip of the coil 14 from an angle θ2 with respect to a plane that is substantial orthogonal to the tungsten rod 16. In this case, it is confirmed that the laser beam may be horizontally emitted to the arc tube part 10 (θ2=0°), because it is not a question toward which electrode's side the melt-cut part moves.

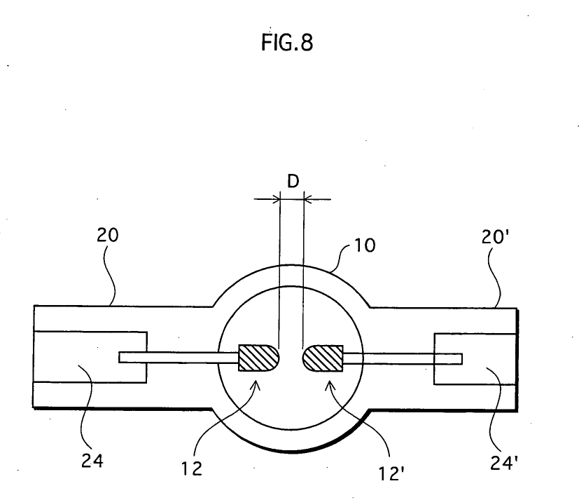

The electrode 12, of which the tungsten rod 16 and the coil 14 are partly melted and integrated with each other and its tip is processed so as to be in the semi-sphere shape, is formed by the second laser irradiation. FIG. 8 shows the arc tube part 10 in which the electrode 12 is formed. Note that after the electrode 12 is formed in the arc tube part 10, the distance D between the electrodes is preferably more than 0 mm and not more than 4.5 mm. It is more preferable that the electrode 12 is not more than 2 mm. As described above, the distance D between the electrodes in final form is approximately 1 mm in this embodiment.

By applying the above-described manufacturing method of the discharge lamp, it becomes easy to control which electrode's side the melt-cut tungsten rod and the coil moves toward. This is preferable for mass production of the discharge lamp.

Note that the discharge lamp produced by the above-describe manufacturing method according to the embodiment can be attached to a projector, such as a liquid crystal projector and a projector using a DMD, and used as a light source for the projector. Other than the light source for the projector, the discharge lamp can be used as a light source for a UV stepper, a light source for a sports stadium, a light source for a headlight of an automobile, and so on.

Modifications

The present invention is described above based on the embodiment. However, as a matter of course, the details of the present invention are not limited to the specific examples shown in the embodiment. For instance, the followings are possible modifications.

(1) In the above-described embodiment, the molybdenum foils 24 and 24′, which are connected to each other, are used as the electrode assembly. However, the molybdenum foils 24 and 24′ can be replaced by the parts of the tungsten rod. In other words, the tungsten rod having covering members, such as coils attached thereto, can be used as the electrode assembly. In this case, the external leads 30 can be constituted of the tungsten rod as well.

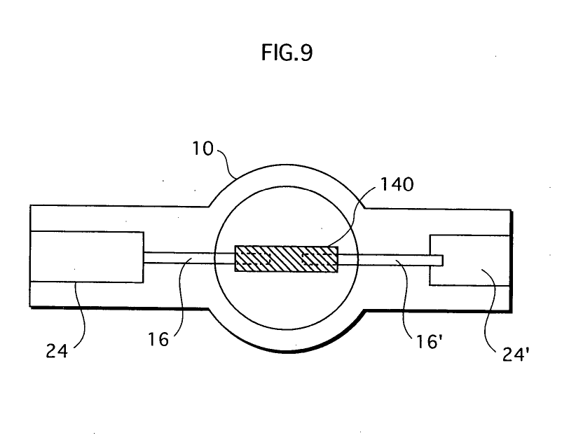

(2) Furthermore, although the one tungsten rod 16, to which the two coils 14 and 14′ are attached, is used as the electrode assembly in the above-described embodiment, the structure of the electrode assembly is not limited to this. For instance, the present invention is applicable in the case where only one tungsten rod without covering members such as coils is used. The present invention is also applicable in the case where the electrode assembly having a structure shown in FIG. 9 is used, for instance. In FIG. 9, one coil 140 is attached to two tungsten rods 16 and 16′ so as to connect the tips of the respective rods to each other. The coil 140 is to be melt-cut at a predetermined position thereon by the laser irradiation.

(3) Although the above-described embodiment precisely describes the case where the present invention is applied to manufacturing of the discharge lamp that encloses mercury having vapor pressure of approximately 20 MPa (a so-called super-high pressure mercury lamp), the present invention is also applicable to a high pressure mercury lamp having mercury vapor pressure of approximately 1 MPa and a low pressure mercury lamp having mercury vapor pressure of 1 kPa. Furthermore, the present invention is applicable to a discharge lamp other than a mercury lamp. For instance, the present invention is applicable to a metal halide lamp within which metal halide is enclosed, and so on.

(4) Although it is preferable to apply the present invention to a short-arc type discharge lamp in which the distance between electrodes D is comparatively short (shorter than 1 mm in the above-described example), the present invention is not limited to this. Furthermore, the present invention is applicable to a direct-current-lighting type discharge lamp as well as to an alternating-current-lighting type discharge lamp.

### INDUSTRIAL APPLICABILITY

As described above, with the discharge lamp manufacturing method according to the present invention, it becomes easy to control which electrode's side the melted electrode material moves toward, by irradiating the electrode material with a laser beam emitted from a direction that forms a predetermined angle θ1 at the time of first laser irradiation. Therefore, the present invention is suitable for mass production of discharge lamps.

1. A discharge lamp manufacturing method for inserting an electrode assembly, which includes a rod that is to be formed into a pair of electrodes, into a discharge-lamp glass bulb having an arc tube part and two side tube parts respectively formed at ends of the arc tube part, sealing each side tube part, and melt-cutting a part of the electrode assembly by irradiating the part with a laser beam emitted from outside of the discharge-lamp glass bulb, the manufacturing method comprising:
a laser irradiation step of irradiating a predetermined site on the electrode assembly with the laser beam emitted from a direction that forms a predetermined angle θ1 with a plane that is orthogonal to a longitudinal direction of the electrode assembly, thereby cutting the part of the electrode assembly, and shaping a tip of one of the electrodes that are formed as a result of the cutting, the predetermined angle θ1 being more than 0°.

2. The discharge lamp manufacturing method of claim 1, wherein
the predetermined angle θ1 is equal to or less than 45°.

3. The discharge lamp manufacturing method of claim 1, wherein
a center point of the predetermined site is nearer to the one of the electrodes than a center point C of the electrode assembly within a discharge space is, the discharge space being formed after each side tube part is sealed.

4. The discharge lamp manufacturing method of claim 1, further comprising:
another laser irradiation step of irradiating the other one of the electrodes with a laser beam, thereby shaping a tip of the other one of the electrodes.

5. The discharge lamp manufacturing method of claim 4, wherein
the electrode assembly is a tungsten rod to which two covering members are attached, the covering members to be respectively fixed to the tips of the electrodes,
in the laser irradiation step, the tungsten rod is cut, and a portion of the tungsten rod, which is to be formed into the one of the electrodes, and a part of one of the covering members are melted and integrated together, and the tip of the one of the electrodes is shaped so as to have a semi-sphere shape, and
in the another laser irradiation step, a portion of the tungsten rod, where is to be formed into the other one of the electrodes, and a part of the other one of the covering members are melted and integrated together, and the tip of the other one of the electrodes is shaped so as to have a semi-sphere shape.

6. The discharge lamp manufacturing method of claim 1, wherein
0 mm<D≦4.5 mm, where D (mm) is a distance between the electrodes in final form.

7. The discharge lamp manufacturing method of claim 2, wherein
a center point of the predetermined site is nearer to the one of the electrodes than a center point C of the electrode assembly within a discharge space is, the discharge space being formed after each side tube part is sealed.

8. The discharge lamp manufacturing method of claim 2, wherein
0 mm<D≦4.5 mm, where D (mm) is a distance between the electrodes in final form.

9. The discharge lamp manufacturing method of claim 4, wherein
0 mm<D≦4.5 mm, where D (mm) is a distance between the electrodes in final form.

10. The discharge lamp manufacturing method of claim 5, wherein
0 mm<D≦4.5 mm, where D (mm) is a distance between the electrodes in final form.
